(19) United States
(12) Patent Application Publication
(10) Pub. No.: US 2017/0024145 A1
(43) Pub. Date: Jan. 26, 2017

(54) ADDRESS TRANSLATION AND DATA PRE-FETCH IN A CACHE MEMORY SYSTEM

(71) Applicant: QUALCOMM INCORPORATED, SAN DIEGO, CA (US)

(72) Inventors: TAREK ZGHAL, San Diego, CA (US); Alain Dominique Artieri, San Diego, CA (US); Jason Edward Podaima, Toronto (CA); Meghal Varia, Brampton (CA); Serag GadelRab, Markham (CA)

(21) Appl. No.: 14/807,754

(22) Filed: Jul. 23, 2015

(51) Int. Cl. G06F 3/06; G06F 12/08

(52) U.S. Cl. CPC G06F 3/0611; G06F 3/0656; G06F 3/0673; G06F 12/0862; G06F 2212/602

(57) ABSTRACT

Systems, methods, and computer program products are disclosed for reducing latency in a system that includes one or more processing devices, a system memory, and a cache memory. A pre-fetch command that identifies requested data is received from a requestor device. The requested data is pre-fetched from the system memory into the cache memory in response to the pre-fetch command. The data pre-fetch may be preceded by a pre-fetch of an address translation. A data access request corresponding to the pre-fetch command is then received, and in response to the data access request the data is provided from the cache memory to the requestor device.

### DESCRIPTION OF THE RELATED ART

A system-on-a-chip (SoC) commonly includes one or more processing devices, such as central processing units (CPUs) and cores, as well as one or more memories and one or more interconnects, such as buses. A processing device may issue a data access request to either read data from a system memory or write data to the system memory. For example, in response to a read access request, data is retrieved from the system memory and provided to the requesting device via one or more interconnects. The time delay between issuance of the request and arrival of requested data at the requesting device is commonly referred to as “latency.” Cores and other processing devices compete to access data in system memory and experience varying amounts of latency.

Caching is a technique that may be employed to reduce latency. Data that is predicted to be subject to frequent or high-priority accesses may be stored in a cache memory from which the data may be provided with lower latency than it could be provided from the system memory. As commonly employed caching methods are predictive in nature, an access request may result in a cache hit if the requested data can be retrieved from the cache memory or a cache miss if the requested data cannot be retrieved from the cache memory. If a cache miss occurs, then the data must be retrieved from the system memory instead of the cache memory, at a cost of increased latency. The more requests that can be served from the cache memory instead of the system memory, the faster the system performs overall.

Although caching is commonly employed to reduce latency, caching has the potential to increase latency in instances in which requested data too frequently cannot be retrieved from the cache memory. Display systems are known to be prone to failures due to latency. “Underflow” is a failure more that refers to data arriving at the display system too slowly to fill the display in the intended manner.

One known solution that attempts to mitigate the above-described problem in display systems is to increase the sizes of buffer memories in display and camera system cores. This solution comes at the cost of increased chip area. Another known solution that attempts to mitigate the problem is to employ faster memory. This solution comes at costs that include greater chip area and power consumption.

### SUMMARY OF THE DISCLOSURE

Systems, methods, and computer programs are disclosed for reducing latency in a system that includes a system memory and a cache memory.

In an exemplary method, a pre-fetch command that identifies requested data is received from a requestor device. The requested data is pre-fetched from the system memory into the cache memory in response to the pre-fetch command. A data access request corresponding to the pre-fetch command is then received, and in response to the data access request the data is provided from the cache memory to the requestor device. The data pre-fetch may be preceded by a pre-fetch of an address translation.

An exemplary system includes a processor system, a system memory, and a cache memory. The processor system is configured with logic to receive from a requestor device a pre-fetch command that identifies requested data. The processor system is further configured with logic to pre-fetch the requested data from the system memory into the cache memory in response to the pre-fetch command. The processor is further configured with logic to respond to a data access request corresponding to the pre-fetch command by providing the data from the cache memory to the requestor device. The data pre-fetch may be preceded by a pre-fetch of an address translation.

An exemplary computer program product includes computer-executable logic embodied in a non-transitory storage medium. Execution of the logic by the processor configures the processor to: receive a pre-fetch command identifying requested data from the requestor device; pre-fetch the requested data from the system memory into the cache memory in response to the pre-fetch command; and respond to a data access request corresponding to the pre-fetch command by providing the requested data from the cache memory to the requestor device. The data pre-fetch may be preceded by a pre-fetch of an address translation.

### BRIEF DESCRIPTION OF THE DRAWINGS

In the Figures, like reference numerals refer to like parts throughout the various views unless otherwise indicated. For reference numerals with letter character designations such as “102A” or “102B”, the letter character designations may differentiate two like parts or elements present in the same Figure. Letter character designations for reference numerals may be omitted when it is intended that a reference numeral to encompass all parts having the same reference numeral in all Figures.

FIG. 1 is a block diagram of a processing system having reduced latency, in accordance with an exemplary embodiment.

FIG. 2 is a flow diagram illustrating an exemplary method for reducing latency in a processing system, in accordance with an exemplary embodiment.

FIG. 3 is another flow diagram illustrating an exemplary method for reducing latency in a processing system, in accordance with an exemplary embodiment.

FIG. 4 is a block diagram of a portable computing device having one or more processing systems, in accordance with an exemplary embodiment.

### DETAILED DESCRIPTION

The word “exemplary” is used herein to mean “serving as an example, instance, or illustration.” Any aspect described herein as “exemplary” is not necessarily to be construed as preferred or advantageous over other aspects.

The terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes, such as in accordance with a signal having one or more data packets (e.g., data from one component interacting with another component in a local system, distributed system, and/or across a network such as the Internet with other systems by way of the signal).

The term “application” or “image” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files that need to be accessed.

The term “task” may include a process, a thread, or any other unit of execution in a device.

The term “virtual memory” refers to the abstraction of the actual physical memory from the application or image that is referencing the memory. A translation or mapping may be used to convert a virtual memory address to a physical memory address. The mapping may be as simple as 1-to-1 (e.g., physical address equals virtual address), moderately complex (e.g., a physical address equals a constant offset from the virtual address), or the mapping may be complex (e.g., every 4 KB page mapped uniquely). The mapping may be static (e.g., performed once at startup), or the mapping may be dynamic (e.g., continuously evolving as memory is allocated and freed).

In this description, the terms “communication device,” “wireless device,” “wireless telephone”, “wireless communication device,” and “wireless handset” are used interchangeably. With the advent of third generation (“3G”) wireless technology and four generation (“4G”), greater bandwidth availability has enabled more portable computing devices with a greater variety of wireless capabilities. Therefore, a portable computing device may include a cellular telephone, a pager, a PDA, a smartphone, a navigation device, or a hand-held computer with a wireless connection or link.

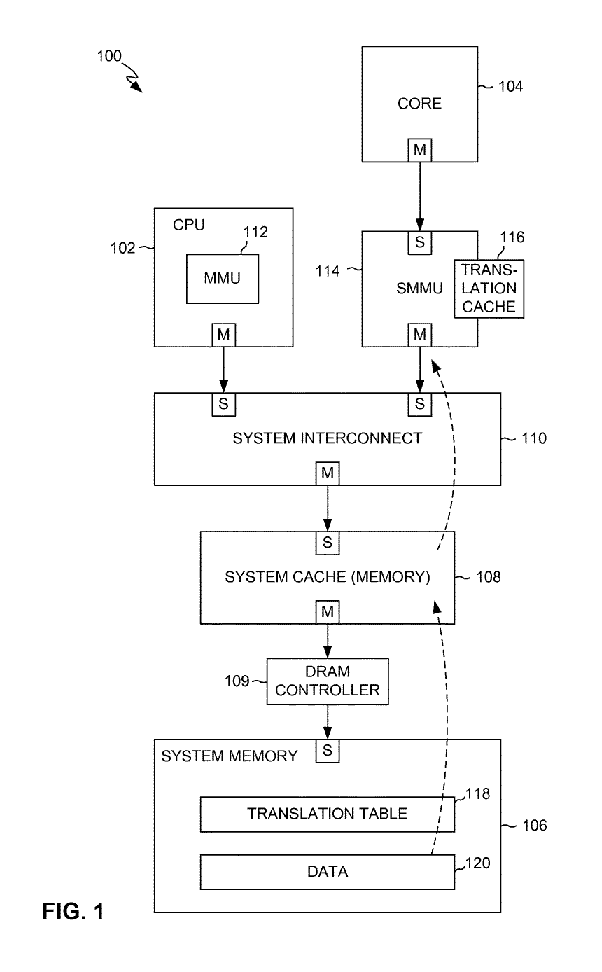

As illustrated in FIG. 1, in an exemplary embodiment a processing system 100 includes one or more processing devices, such as a central processing unit (“CPU”) 102 or a core 104. Processing system 100 further includes a system memory 106 and a system cache (memory) 108. System memory 106 may comprise dynamic random access memory (“DRAM”). A DRAM controller 109 associated with system memory 106 may control accessing system memory 106 in a conventional manner. A system interconnect 110, which may comprise one or more busses and associated logic, interconnects the processing devices, memories, and other elements of processing system 100.

The terms “upstream” and “downstream” may be used for convenience to reference information flow among the elements of processing system 100. The terms “master” and “slave” may be used for convenience to refer to elements that respectively initiate requests and respond to requests. Elements of processing system 100 are characterized by either a master (“M”) manner of coupling to a downstream device, a slave (“S”) manner of coupling to an upstream device, or both. It should be understood that the arrows shown in FIG. 1 between elements of processing system 100 are intended only to refer to the request-response operation of master and slave devices, and that the communication of information between the devices may be bidirectional.

CPU 102 includes a memory management unit (“MMU”) 112. MMU 112 comprises logic (e.g., hardware, software, or a combination thereof) that performs address translation for CPU 102. Although for purposes of clarity MMU 112 is depicted in FIG. 1 as being included in CPU 112, MMU 112 may be externally coupled to CPU 102.

Processing system 100 also includes a system MMU (“SMMU”) 114. An SMMU provides address translation services for upstream device traffic in much the same way that a processor's MMU, such as MMU 112, translates addresses for processor memory accesses. SMMU 114 includes or is coupled to one or more translation caches 116. Although not illustrated in FIG. 1 for purposes of clarity, MMU 112 may also include or be coupled to one or more translation caches. System cache 108 may be used as a translation cache.

The main functions of MMU 112 and SMMU 114 include address translation, memory protection, and attribute control. Address translation is a method by which an input address in a virtual address space is translated to an output address in a physical address space. Translation information is stored in translation tables that MMU 112 or SMMU 114 references to perform address translation, such as a translation table 118 stored in system memory 106. There are two main benefits of address translation. First, address translation allows a processing device to address a large physical address space. For example, a 32 bit processing device (i.e., a device capable of referencing 2³² address locations) can have its addresses translated such that the processing device may reference a larger address space, such as a 36 bit address space or a 40 bit address space. Second, address translation allows processing devices to have a contiguous view of buffers allocated in memory, despite the fact that memory buffers are typically fragmented, physically non-contiguous, and scattered across the physical memory space.

Translation table 118 contains information necessary to perform address translation for a range of input addresses. Although not shown in FIG. 1 for purposes of clarity, this information may include a set of sub-tables arranged in a multi-level “tree” structure. Each sub-table may be indexed with a sub-segment of the input address. Each sub-table may include translation table descriptors. There are three base types of descriptors: (1) an invalid descriptor, which contains no valid information; (2) table descriptors, which contain a base address to the next level sub-table and may contain translation information (such as access permission) that is relevant to all sub-sequent descriptors encountered during the walk; and (3) block descriptors, which contain a base output address that is used to compute the final output address and attributes/permissions relating to block descriptors.

The process of traversing translation table 118 to perform address translation is known as a “translation table walk.” A translation table walk is accomplished by using a sub-segment of an input address to index into the translation sub-table, and finding the next address until a block descriptor is encountered. A translation table walk comprises one or more “steps.” Each “step” of a translation table walk involves: (1) an access to translation table 118, which includes reading (and potentially updating) it; and (2) updating the translation state, which includes (but is not limited to) computing the next address to be referenced. Each step depends on the results from the previous step of the walk. For the first step, the address of the first translation table entry that is accessed is a function of the translation table base address and a portion of the input address to be translated. For each subsequent step, the address of the translation table entry accessed is a function of the translation table entry from the previous step and a portion of the input address.

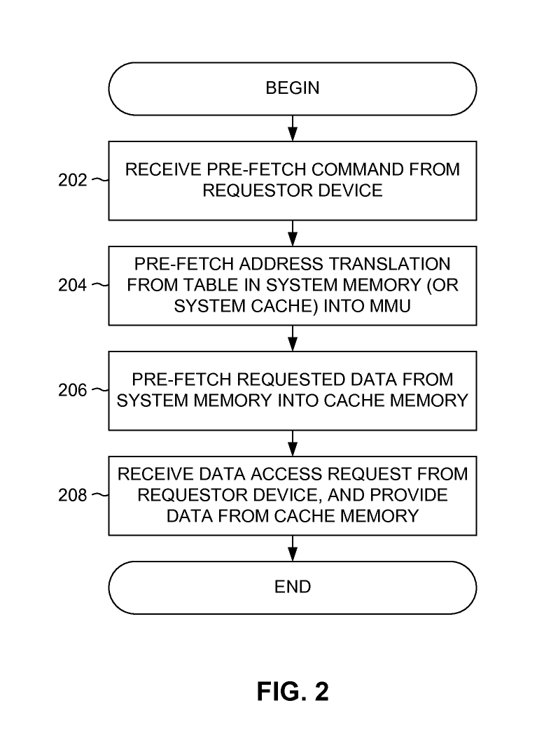

The following exemplary method for reading data 120 from system memory 106 with minimal latency is described with reference to the flow diagram of FIG. 2. As indicated by block 202, a pre-fetch command is received from a requestor device, such as core 104 or CPU 102 (FIG. 1). In the embodiment shown in FIG. 1, MMU 112 and SMMU 114 may include logic configured for receiving the pre-fetch command. In an embodiment (not shown) in which there is no MMU or SMMU upstream of a requestor device, such logic may be included in the requestor device itself.

The pre-fetch command identifies data requested by the requestor device. To identify data, the pre-fetch command may indicate an address of requested data. Alternatively, the pre-fetch command may indicate a pattern of addresses. The multiple addresses indicated by such a pattern may or may not be contiguous. The pattern thus corresponds to an amount of requested data. In an embodiment (not shown) in which there is no SMMU upstream of a requestor device or MMU associated with a requestor device, the address or address pattern indicated by the pre-fetch command may be a physical address of requested data 120 in system memory 106. However, in the exemplary embodiment shown in FIG. 1, MMU 112 or SMMU 114 may perform an address translation method to obtain one or more physical addresses, as indicated by block 204.

In response to receiving the pre-fetch command, MMU 112 or SMMU 114 may first determine whether the one or more address translations implicated by the address indicated in the pre-fetch command are already accessible (e.g., stored in translation cache 116). If the one or more address translations are not already accessible, then MMU 112 or SMMU 114 accesses translation table 118 or system cache 108 and performs address translation methods in the manner described above, as may be needed to make the address translations accessible. For example, SMMU 114 may store the resulting address translation in translation cache 116.

As indicated by block 206, requested data 120 is then pre-fetched from system memory 106 into system cache 108. Although in the exemplary embodiment shown in FIG. 1 MMU 112 or SMMU 114 may use the address translation to pre-fetch the requested data 120 from system memory 106 into system cache 108, in an embodiment (not shown) in which there is no SMMU upstream of a requestor device or MMU associated with a requestor device (or an embodiment in which there is a mode of operation that bypasses the translation), the requestor device may pre-fetch the requested data from system memory 106 into system cache 108 using one or more physical addresses. It may also be possible for a requestor device to bypass an SMMU and provide physical addresses for pre-fetching the requested data from system memory 106 into system cache 108.

As indicated by block 208, a data access request is received from the requestor device. The data access request corresponds to the pre-fetch command. That is, for each data access request that the requestor device issues, the requestor device also issues a corresponding pre-fetch command. Although in the exemplary embodiments there is a one-to-one correspondence between data access requests and pre-fetch commands, in other embodiments there can be other relationships between data access requests and pre-fetch commands. In response to the data access request, the requested data 120 is provided from cache memory 108 to the requestor device.

The above-described exemplary method exploits the fact that in some types of processing systems, the address pattern in which the relevant data is stored is available to the requestor device well in advance of the time at which the data needs to be processed. For example, core 104 may be included in a display processing system that displays data on a display screen (not shown in FIGS. 1-2). The addresses at which the data to be displayed is stored is available to core 104 well before the time at which the data needs to be displayed, because data to be displayed is stored or otherwise addressable in a pattern that is known to, i.e., available to, core 104. In the exemplary embodiment described herein, the relationship between information to be displayed and the address of the corresponding data is readily determinable by core 104. As core 104 determines that certain information will need to be displayed, core 104 may issue the above-described pre-fetch command and corresponding data access request for the data corresponding to that information because core 104 is capable of determining the corresponding addresses.

It follows from the above that it may be advantageous for a requestor device to issue the pre-fetch command a sufficient amount of time in advance of the corresponding data access request to allow the requested data 120 to become available in system cache 108 for immediate transfer to the requestor device in response to the data access request. However, it may be disadvantageous for a requestor device to issue the pre-fetch command so far in advance of the corresponding data access request that the likelihood of the data being overwritten or evicted from system cache 108 is increased.

The above-described method not only reduces latency but also may be used to promote power conservation. A requestor device, such as CPU 102 or core 104, may instruct DRAM controller 109 and other circuitry associated with system memory 106 to enter a low-power mode after pre-fetching a block of requested data 120 from system memory 106 into system cache 108.

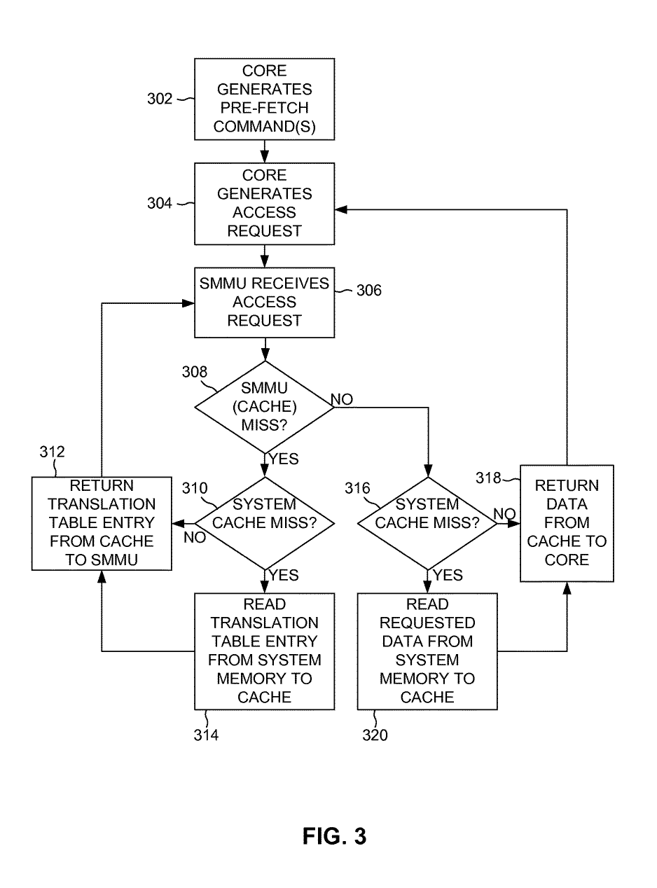

Further details of the above-referenced address translation and information flows may be appreciated in the following exemplary method, which is described with reference to the flow diagram of FIG. 3. As indicated by block 302, core 104 may generate a pre-fetch command. As indicated by block 304, core 104 may generate a data access request corresponding to the pre-fetch command.

As indicated by block 306, SMMU 114 may receive the pre-fetch command or data access request generated by core 104. Block 306 exemplifies a time delay between elements. As described below, the method may promote reduction in certain time delays and thus overall latency. This particular time delay between the time at which core 104 generates a pre-fetch command or data access request and the time at which SMMU 114 receives the pre-fetch command or data access request may be referred to herein as “a0” and is considered in further detail below.

It should be noted that SMMU 114 responds to a pre-fetch command in a manner similar to that in which it responds to a data access request. However, SMMU 114 does not return the requested data to core 104 in response to a pre-fetch command. Rather, the pre-fetch command results in the requested data being made available in system cache 108. It is not until SMMU 114 receives the data access request corresponding to an earlier pre-fetch command that SMMU 114 responds by providing the requested data from system cache 108 to core 104.

As indicated by block 308, SMMU 114 determines whether the address translation needed to access the requested data is available in translation cache 116. A determination that the address translation is not available in translation cache 116 may be referred to as an MMU translation cache miss. If it is determined that such an MMU translation cache miss occurred, then it is determined whether the address translation is available in system cache 108, as indicated by block 310. The time delay for the determination that a translation cache miss occurred to trigger a search of system cache 108 for the address translation may be referred to herein as “b0.” A determination that an address translation is not available in system cache 108 may be referred to as a system cache miss. If it is determined (block 310) that a system cache miss did not occur, then the address translation is returned to SMMU 114 (i.e., to translation cache 116), as indicated by block 312. The time delay for the address translation to be returned to SMMU 114 may be referred to herein as “b1.”

If it is determined (block 310) that a system cache miss occurred, then an address translation method is begun by accessing translation table 118 in system memory 106, as indicated by block 314. The time delay for the determination that a system cache miss occurred to trigger SMMU 114 to access translation table 118 may be referred to herein as “c0.” The translation table entry obtained from translation table 118 is then stored in translation cache 116 for use by SMMU 114 in the address translation method. The time delay for the translation table entry to be stored in translation cache 116 is “b1” plus an additional delay “c1.” Note that SMMU 114 may generate multiple accesses of translation table 118 in association with performing the address translation method.

If it is determined (block 308) that no translation cache miss occurred, then it is determined whether the requested data 120 is available in system cache 108 as indicated by block 316. As stated above, the time delay for a determination that a translation cache miss occurred to trigger a search of system cache 108 is “b0.” If it is determined (block 316) that no system cache miss occurred, then the requested data 120 is returned to core 104, as indicated by block 318. However, if it is determined (block 316) that a system cache miss occurred, then the requested data 120 must be read from system memory 106 into system cache 108, as indicated by block 320. Although in the exemplary embodiment such requested data 120 may be read into system cache 108, it should be understood that in other embodiments the requested data alternatively may be transferred directly to the core or other requestor device without storing it in system cache. For example, display data may be transferred directly to a core that requested the display data, since display data is generally not reused.

The time delay for the determination that a system cache miss occurred to trigger SMMU 114 to access system memory 106 is “c0.” The time delay for the requested data 120 to be read from system memory 106 into system cache 108 is “c1.” The requested data 120 is then returned to core 104, as indicated by block 318. The time delay for requested data 120 to traverse SMMU 114 and reach core 104 may be referred to as “a1.”

In the absence of a pre-fetch command, the total time delay or access time (“T”) between core 104 issuing a data access request and the requested data 120 being returned to core 104 is: T=a0+Mmiss*(b0+b1+c0+c1)+Mhit*(b0+b1)+b0+c0+b1+c1+a1, where “Mmiss” is the number of accesses generated by SMMU 114 to obtain the translation table entry that resulted in a system cache miss, “Mhit” is the number of accesses generated by SMMU 114 to obtain the translation table entry that resulted in a system cache hit, and where Mmiss>=0, and Mhit>=0.

However, by core 104 issuing a pre-fetch command an optimal amount of time in advance of issuing a data access request, then the requested data 120 will be available in system cache 108 for immediate access by core 104, thus reducing the total delay to: T′=a0+b0+b1+a1. This assumes that the translation table entry is also prefetched in the MMU ahead of time.

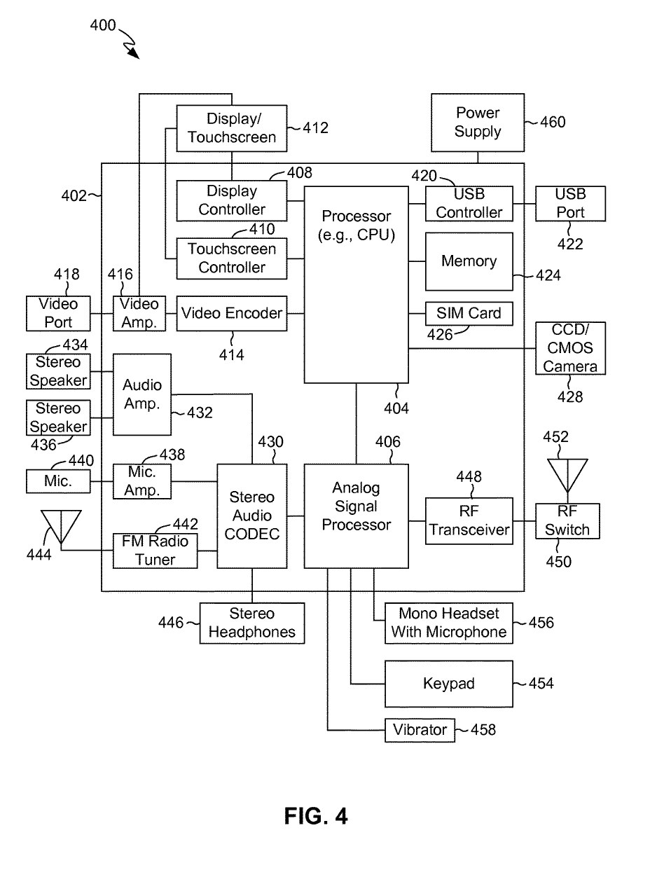

Processing system 100 (FIG. 1) may represent or be included in any suitable type of device, such as, for example, the portable communication device 400 illustrated in FIG. 4. Portable communication device 400 includes an on-chip system 402 that includes a central processing unit (“CPU”) 404. An analog signal processor 406 is coupled to CPU 404. A display controller 408 and a touchscreen controller 410 are coupled to the CPU 404. CPU 404, display controller 408, or other processing device may be configured to generate pre-fetch commands and data access requests in the manner described above with respect to the above-described methods. A touchscreen display 412 external to the on-chip system 402 is coupled to the display controller 408 and the touchscreen controller 410. Display controller 408 and touchscreen display 412 may together define a display system configured to generate pre-fetch commands and data access requests for data to be displayed on touchscreen display 412.

A video encoder 414, e.g., a phase-alternating line (“PAL”) encoder, a sequential couleur avec memoire (“SECAM”) encoder, a national television system(s) committee (“NTSC”) encoder or any other video encoder, is coupled to CPU 404. Further, a video amplifier 416 is coupled to the video encoder 414 and the touchscreen display 412. A video port 418 is coupled to the video amplifier 416. A USB controller 420 is coupled to CPU 404. A USB port 422 is coupled to the USB controller 420. A memory 424, which may operate in the manner described above with regard to system memory 106 (FIG. 1), is coupled to CPU 404. A subscriber identity module (“SIM”) card 426 and a digital camera 428 also may be coupled to CPU 404. In an exemplary aspect, the digital camera 428 is a charge-coupled device (“CCD”) camera or a complementary metal-oxide semiconductor (“CMOS”) camera.

A stereo audio CODEC 430 may be coupled to the analog signal processor 406. Also, an audio amplifier 432 may be coupled to the stereo audio CODEC 430. In an exemplary aspect, a first stereo speaker 434 and a second stereo speaker 436 are coupled to the audio amplifier 432. In addition, a microphone amplifier 438 may be coupled to the stereo audio CODEC 430. A microphone 440 may be coupled to the microphone amplifier 438. A frequency modulation (“FM”) radio tuner 442 may be coupled to the stereo audio CODEC 430. Also, an FM antenna 444 is coupled to the FM radio tuner 442. Further, stereo headphones 446 may be coupled to the stereo audio CODEC 430.

A radio frequency (“RF”) transceiver 448 may be coupled to the analog signal processor 406. An RF switch 450 may be coupled between the RF transceiver 448 and an RF antenna 452. The RF transceiver 448 may be configured to communicate with conventional terrestrial communications networks, such as mobile telephone networks, as well as with global positioning system (“GPS”) satellites.

A mono headset with a microphone 456 may be coupled to the analog signal processor 406. Further, a vibrator device 458 may be coupled to the analog signal processor 406. A power supply 460 may be coupled to the on-chip system 402. In a particular aspect, the power supply 460 is a direct current (“DC”) power supply that provides power to the various components of the portable communication device 400 that require power. Further, in a particular aspect, the power supply is a rechargeable DC battery or a DC power supply that is derived from an alternating current (“AC”) to DC transformer that is connected to an AC power source.

A keypad 454 may be coupled to the analog signal processor 406. The touchscreen display 412, the video port 418, the USB port 422, the camera 428, the first stereo speaker 434, the second stereo speaker 436, the microphone 440, the FM antenna 444, the stereo headphones 446, the RF switch 450, the RF antenna 452, the keypad 454, the mono headset 456, the vibrator 458, and the power supply 460 are external to the on-chip system 402.

One or more of the method steps described herein (such as described above with regard to FIGS. 2 and 3) may be stored in memory 106 (FIG. 1) or memory 424 (FIG. 4) as computer program instructions. The combination of such computer program instructions and the memory or other medium on which they are stored or in which they reside in non-transitory form generally defines what is referred to in the patent lexicon as a “computer program product.” These instructions may be executed by CPU 404, display controller 408, or another processing device, to perform the methods described herein. Further, CPU 404, display controller 408, or another processing device, or such a processing device in combination with memory 424, as configured by means of the computer program instructions, may serve as a means for performing one or more of the method steps described herein.

Alternative embodiments will become apparent to one of ordinary skill in the art to which the invention pertains without departing from its spirit and scope. Therefore, although selected aspects have been illustrated and described in detail, it will be understood that various substitutions and alterations may be made therein without departing from the spirit and scope of the present invention, as defined by the following claims.

What is claimed is:

1. A method for reducing latency in a system comprising a system memory and a cache memory, the method comprising:
receiving a pre-fetch command from a requestor device, the pre-fetch command identifying requested data;
pre-fetching the requested data from the system memory into the cache memory in response to the pre-fetch command;
receiving a data access request corresponding to the pre-fetch command; and
providing the data from the cache memory to the requestor device in response to the data access request.

2. The method of claim 1, further comprising:
pre-fetching an address translation from a translation table in the system memory into a memory management unit in response to the pre-fetch command;
wherein pre-fetching the requested data from the system memory into the cache memory is further in response to the address translation.

3. The method of claim 1, wherein the requestor device is a core associated with a display system, and the requested data comprises display data.

4. The method of claim 3, wherein the requestor device is included in a portable computing device having a display, the portable computing device comprising at least one of a mobile telephone, a personal digital assistant, a pager, a smartphone, a navigation device, and a hand-held computer with a wireless connection or link.

5. The method of claim 1, wherein the pre-fetch command includes descriptor information indicating a pattern of a plurality of addresses corresponding to an amount of requested data.

6. The method of claim 5, wherein the descriptor information further indicates whether to instruct a memory controller to enter a low-power mode after pre-fetching the requested data from the system memory into the cache memory.

7. The method of claim 1, wherein the pre-fetch command includes descriptor information indicating whether to bypass prefetching by not fetching the requested data from the system memory into the cache memory until the data access request is received.

8. A system, comprising:
a system memory;
a cache memory;
pre-fetch logic configured to receiving a pre-fetch command from a requestor device, the pre-fetch command identifying requested data, the pre-fetch logic further configured to pre-fetch the requested data from the system memory into the cache memory in response to the pre-fetch command; and
memory control logic configured to receive a data access request corresponding to the pre-fetch command and provide the data from the cache memory to the requestor device in response to the data access request.

9. The system of claim 8, wherein the pre-fetch logic is further configured to pre-fetch an address translation from a translation table in the system memory into a memory management unit in response to the pre-fetch command, and wherein the requested data is pre-fetched from the system memory into the cache memory in response to the address translation.

10. The system of claim 8, wherein the requestor device is a core associated with a display system, and the requested data comprises display data.

11. The system of claim 10, wherein the system memory, cache memory, processing system and requestor device are included in a portable computing device having a display, the portable computing device comprising at least one of a mobile telephone, a personal digital assistant, a pager, a smartphone, a navigation device, and a hand-held computer with a wireless connection or link.

12. The system of claim 8, wherein the pre-fetch command includes descriptor information indicating a pattern of a plurality of addresses corresponding to an amount of requested data.

13. The system of claim 12, wherein the descriptor information further indicates whether to instruct a memory controller to enter a low-power mode after pre-fetching the requested data from the system memory into the cache memory.

14. The system of claim 8, wherein the pre-fetch command includes descriptor information indicating whether to bypass prefetching by not fetching the requested data from the system memory into the cache memory until the data access request is received.

15. A computer program product comprising computer-executable logic embodied in a non-transitory storage medium, execution of the logic by a processing system configuring the processing system to:
receive a pre-fetch command from a requestor device, the pre-fetch command identifying requested data;
pre-fetch the requested data from the system memory into the cache memory in response to the pre-fetch command;
receive a data access request corresponding to the pre-fetch command; and
provide the data from the cache memory to the requestor device in response to the data access request.

16. The computer program product of claim 15, wherein execution of the logic further configures the processing system to:
pre-fetch an address translation from a translation table in the system memory into a memory management unit in response to the pre-fetch command;
wherein pre-fetching the requested data from the system memory into the cache memory is further in response to the address translation.

17. The computer program product of claim 15, wherein the pre-fetch command includes descriptor information indicating a pattern of a plurality of addresses corresponding to an amount of requested data.

18. The computer program product of claim 17, wherein the descriptor information further indicates whether to instruct a memory controller to enter a low-power mode after pre-fetching the requested data from the system memory into the cache memory.

19. The computer program product of claim 15, wherein the pre-fetch command includes descriptor information indicating whether to bypass prefetching by not fetching the requested data from the system memory into the cache memory until the data access request is received.

20. The computer program product of claim 15, wherein the requestor device is a core associated with a display system, and the requested data comprises display data.
